(19) United States
(12) Patent Application Publication
(10) Pub. No.: US 2007/0072073 A1
(43) Pub. Date: Mar. 29, 2007

(54) Sealed cell and method of producing same

(75) Inventor: Yasunobu Kodama, Sumoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/526,710

(22) Filed: Sep. 26, 2006

(30) Foreign Application Priority Data
Sep. 28, 2005 (JP) 2005-282617

(51) Int. Cl. H01M 2/06; H01M 2/08

(52) U.S. Cl. 429/181; 429/185; 29/623.2

(57) ABSTRACT

A sealed cell is provided having increased insulation between the current-collecting tab and the metal layer of a film outer casing, and providing easy mounting of a protection circuit or the like. The sealed cell has an electrode assembly composed of a positive electrode having a current-collecting tab and a negative electrode having a current-collecting tab. The electrode assembly is housed in a film outer casing formed of laminate films each of a metal layer and a resin layer, and the laminate films is heat-sealed into a form of a container. The outer casing has a tab-protruding sealed portion formed by heat-sealing while sandwiching the positive and negative current-collecting tabs with the tips of thereof protruding outside the outer casing. A heat-sealable insulating sheet is heat-sealed onto one of cross sections of the laminate films constituting an end surface of the outer casing, whereby the one of the cross sections is covered with the heat-sealable insulating sheet.

### BACKGROUND OF THE INVENTION

1) Field of the Invention

The present invention relates to cells using, as the cell cases, film outer casings (jackets) such as laminate films.

2) Description of the Related Art

Following a demand for a size reduction of mobile electronic appliances such as mobile phones and personal digital assistants, cells and batteries serving as the driving power sources of such appliances are required to be even thinner and lighter in weight.

In order to meet this demand, there is developed a light-weight thin cell that uses, as the cell case, a film outer casing formed of a laminate film in which a metal layer 100 such as aluminum and resin layers 101 and 102 are laminated, as shown in FIG. 3. This cell, which uses a laminate film, is sealed by a method as shown in FIG. 5, where a rectangular laminate film is folded and three side edges (4a, 4b, 4c) are bonded by heat compression or the like.

FIG. 6 is a partly enlarged cross sectional view of a tab-protruding sealed portion 4a of the light-weight thin cell. As shown in FIG. 6(a), the tab-protruding sealed portion 4a, which is sealed with a current-collecting tab 7 protruding, is not sealed at a tab-protruding edge portion 3a of the outer casing. This is for the purpose of preventing degradation of sealing performance that occurs in the following manner. At the time of the bonding by heat compression for sealing, the tab-protruding edge portion 3a of the outer casing tends to have strong pressure that makes the thickness of the resin layer 102 thin. This brings the metal layer 100 into contact with the current-collecting tab 7, and thus the metal layer 100 is polarized. This leads to corrosion of the metal layer 100, resulting in degradation of sealing performance.

The tab-protruding edge portion 3a of the outer casing has a laminate-film cross section 3b where the metal layer 100 is exposed. As shown in FIG. 6(b), when the current-collecting tab 7 is folded so that the tab 7 is connected to a terminal or a wiring, the metal layer 100 at the cross section 3b and the current-collecting tab 7 come into contact with each other (the portion circled in the figure), resulting in the above-described problem.

The tab-protruding sealed portion 4a is thinner than the portion where the electrode assembly is inserted, and in order to make a good use of this space, a protection circuit or the like is mounted there. However, also in this case, if a wiring or a terminal of the protection circuit comes into contact with the metal layer 100 at the cross section 3b, the above-described problem occurs.

In order to solve this problem, patent documents 1 and 2 propose a technique to mount an insulating member on the edge portion of the laminate film. These documents are summarized as follows.

Patent document 1: Japanese Patent Application Publication No. 2000-251854;

Patent document 2: Japanese Patent Application Publication No. 2004-87422.

(1) Patent document 1 describes a technique to provide a moisture-proof portion extending along and surrounding the edge portion of the outer casing film. According to this technique, the moisture-proof property of the outer casing at the sealed portion is enhanced.

(2) Patent document 2 discloses a technique to form an insulating coating along the side portions of an outer casing material by attaching melted resin on the side portions and curing the melted resin using UV rays or the like. According to this technique, the location and length of the insulating coating can be set in an arbitrary manner.

However, with these techniques the moisture-proof portion and insulating coating increase the thickness of the tab-protruding sealed portion, and thus the space for mounting the protection circuit is made small, making it difficult to mount the protection circuit.

(3) As shown in FIG. 6(c), also proposed is a technique to mount an insulating tab film 5 on the current-collecting tab 7 thereby preventing contact between the exposed metal layer 100 and the current-collecting tab 7 at the cross section 3b. If this technique is employed, however, the insulating tab film 5 cannot be mounted on the entire surface of the current-collecting tab 7 since current is fed from the current-collecting tab 7. Thus, contact may occur between a portion of the current-collecting tab 7 where the insulating tab film 5 is not mounted and the exposed metal layer 100 at the cross section 3b, or between a wiring, terminal, or the like of the protection circuit mounted on the current-collecting tab and the exposed metal layer 100 at the cross section 3b, resulting in the above-described problem.

### SUMMARY OF THE INVENTION

In view of the above-described and other problems, it is an object of the present invention to provide a cell using a film outer casing in which insulation between the current-collecting tab and the metal layer of the outer casing is secured and in which a space for locating the protection circuit and the like is secured.

In order to accomplish the above and other objects, the cell according to the present invention is configured as follows.

A sealed cell comprising: an electrode assembly comprising a positive electrode having a positive-electrode current-collecting tab, and a negative electrode having a negative-electrode current-collecting tab; and a film outer casing for housing the electrode assembly, the film outer casing being formed of laminate films each of a metal layer and a resin layer, the laminate films being heat-sealed into a form of a container, wherein: the outer casing has a tab-protruding sealed portion formed by heat-sealing while sandwiching the positive and negative electrode current-collecting tabs with tips thereof protruding outside the outer casing; and a heat-sealable insulating sheet is attached to one of cross sections of the laminate films constituting an end surface of the outer casing, whereby the one of the cross sections is covered with the heat-sealable insulating sheet.

In this structure, as shown in FIGS. 4(b) and 4(d), a heat-sealable insulating sheet 20 is heat-sealed to one of the cross sections 3b of the laminate films constituting the end surface 3c of the outer casing through which the current-collecting tabs 7 and 8 are protruding, whereby the metal layer 100 at the outer-casing cross section 3b is covered with the insulating sheet 20. (This is shown by the encircled portion in FIG. 4(b).) This reliably prevents contact between the metal layer 100 and the current-collecting tab 7. As a result of heat sealing, pressure is applied on the outer-casing edge portion 3a, which makes small the thickness L1 of the outer-casing edge portion 3a, thereby making it easy to mount the protection circuit or the like in this space. Further, because folding of the two current-collecting tabs 7 and 8 and mounting of the protection circuit are generally made in the same direction, heat sealing of the insulating sheet made on one surface (the surface on which folding is carried out) of the outer casing suffices in order to obtain the above advantageous effects.

The current-collecting tabs may each have insulating tab films extending from the tab-protruding sealed portion toward the sides of the tips of the current-collecting tabs, the insulating sheet and the tab films being heat-sealed together.

With this structure, the tab films 5 and the insulating sheet 20 cooperate to prevent contact between the metal layer 100 and the current-collecting tab 7.

The insulating sheet may be of a multi-layered structure including an adhesion layer and a heat-resistant layer, the heat-resistant layer having a melting point and a decomposition temperature higher than those of the adhesion layer.

With this structure, as shown in FIGS. 4(a) and 4(b), the insulating sheet 20 is heat-sealed with the heat-resistant layer 22 on the outer side and the adhesion layer 21 on the inner side, which eliminates adhesion between a heating apparatus and the heat-resistant layer. Thus, the adhesion layer 21 can be heat-sealed to the outer-casing cross section to a sufficient degree, resulting in enhanced reliability of heat sealing.

In order to accomplish the above and other objects, the method of producing the cell according to the present invention is configured as follows.

A method for producing a sealed cell formed of an electrode assembly having a positive electrode having current-collecting tab and a negative electrode having a current-collecting tab, the electrode assembly being housed in a container-formed outer casing formed of laminate films each of a metal layer and a resin layer with the resin layer being on the inner side, the method comprising: placing the electrode assembly into the outer casing from an opening portion thereof with tips of the positive and negative current-collecting tabs protruding outside the outer casing, and heat-sealing the opening portion with the positive and negative current-collecting tabs sandwiched between the sealed opening portion, whereby a tab-protruding sealed portion is formed; and placing an insulating sheet onto one of cross sections of the laminate films constituting an end surface of the outer casing having the current-collecting tabs protruding therethrough, and heat-bonding the insulating sheet with pressure onto the one of the cross sections at a temperature lower than a temperature for heat-sealing the opening portion of the outer casing, whereby the one of the cross sections is covered with the insulating sheet.

With this structure, it is possible to reliably prevent contact between the metal layer at the cross section of the laminate film and the current-collecting tab or the protection circuit, and to reduce the thickness of the outer casing at around the tab-protruding sealed portion. Thus, it becomes easy to mount the protection circuit or the like.

### BRIEF DESCRIPTION OF THE DRAWINGS

FIG. 1 is a front view of a cell having a film outer casing according to the present invention.

FIG. 2 is a cross sectional view of the cell taken along the line A-A in FIG. 1.

FIG. 3 is a view showing a cross sectional structure of an aluminum laminate film that is a constituent material of the film outer casing.

FIG. 4 is a partly enlarged view showing the step of mounting an insulating sheet in the cell according to Example 1 of the present invention.

FIG. 5 is a front view of a conventional cell provided with a film outer casing.

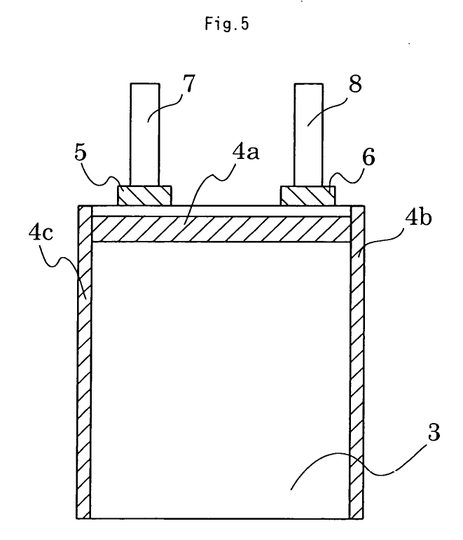

FIG. 6 is a view illustrating contact between the metal layer and the current-collecting tab in the outer casing of a conventional cell.

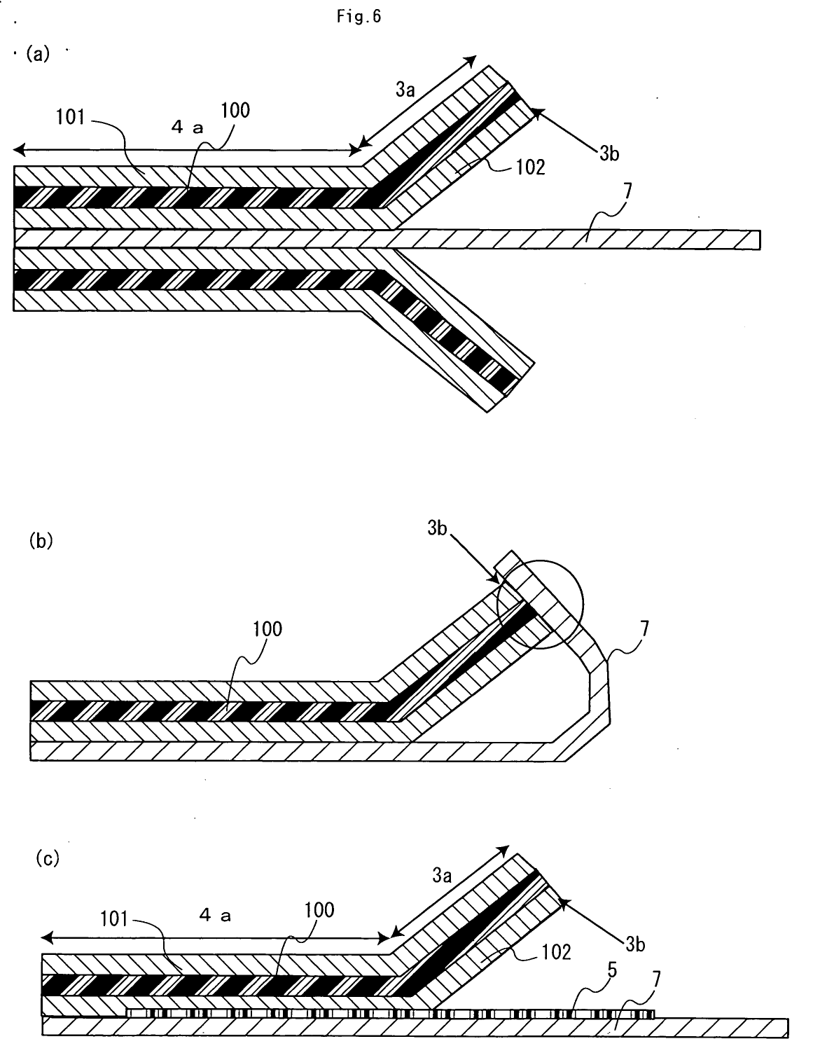

FIG. 7 is a schematic view illustrating a short circuit test.

FIG. 8 is a perspective view of an electrode assembly used in the present invention.

### Description of Numeral

1 Electrode assembly

2 Housing space

3 Film outer casing

4a, 4b, 4c Sealed portion

5 Positive-electrode current-collecting tab protection tape

6 Negative-electrode current-collecting tab protection tape

7 Positive-electrode current-collecting tab

8 Negative-electrode current-collecting tab

20 Insulating sheet

21 Polypropylene layer

22 Heat-resistant layer

100 Metal layer

101 Nylon layer

102 Polypropylene layer

103 Dry laminate adhesive layer

104 Carboxylic-acid modified polypropylene layer

### DESCRIPTION OF THE PREFERRED EMBODIMENTS

The following is a description of a case in which the cell according to the present invention is applied to a lithium ion secondary cell in conjunction with drawings.

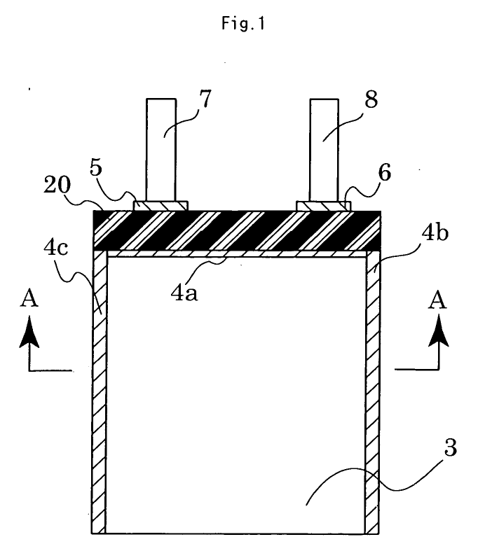

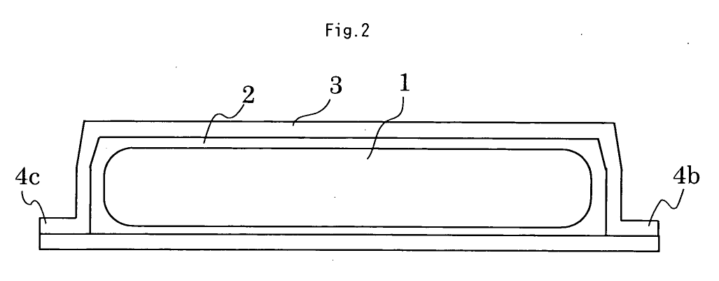

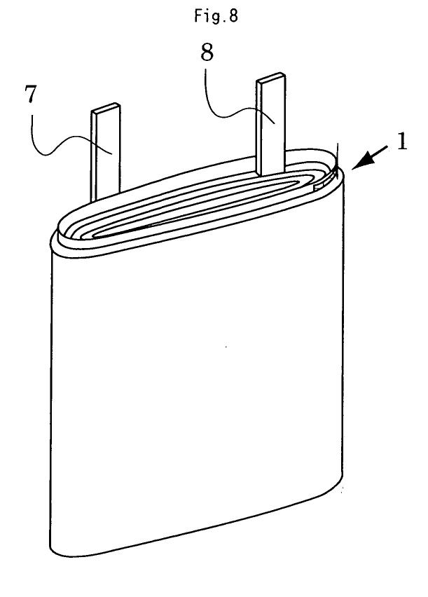

Referring to FIGS. 1 and 2, a lithium ion secondary cell according to the present invention has an aluminum laminate outer casing 3 using an aluminum laminate material, which is an example of the film outer casing. As shown in FIG. 1, this aluminum laminate outer casing 3 has a bottom portion formed by folding a film, a tab-protruding sealed portion 4a that seals an opening portion with the positive and negative electrode current-collecting tabs protruding through the opening portion, and side-edge sealed portions 4b and 4c. The sides of this flat shape are sealed except for the above-mentioned bottom portion, resulting in a three-side sealed structure. A housing space 2 is formed inside a body portion delimited by the bottom portion and the three-side sealed portions 4a, 4b, and 4c (see FIG. 2), and in this housing space 2 are housed a flat electrode assembly of the structure shown in FIG. 8 and a non-aqueous electrolytic solution.

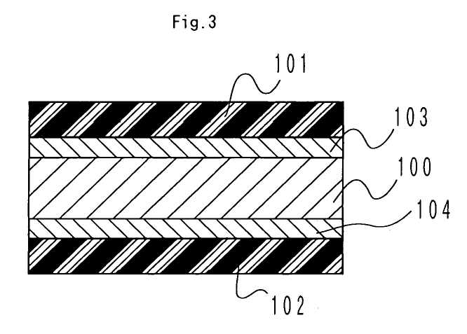

Next, an aluminum laminate material, which is a constituent material of the outer casing 3, will be described. The aluminum laminate material, whose cross section is shown in FIG. 3, is of such a structure that on one surface of a metal layer 100 formed of aluminum of 35 μm thick, a nylon layer 101 (a layer on the outer surface of the cell) of 15 μm thick is formed, and on the other surface of the metal layer 100, a polypropylene layer 102 (a layer on the inner surface of the cell) of 25 μm thick is formed. Also, the structure is such that the metal layer 100 and the nylon layer 101 are adhered together with a dry laminate adhesive layer 103 of 5 μm thick, and the metal layer 100 and the polypropylene layer 102 are adhered together with a carboxylic-acid modified polypropylene layer 104 of 5 μm thick having a carboxyl group added to polypropylene.

It should be noted that applications of the present invention will not be limited to an outer casing using an aluminum laminate material of the above structure.

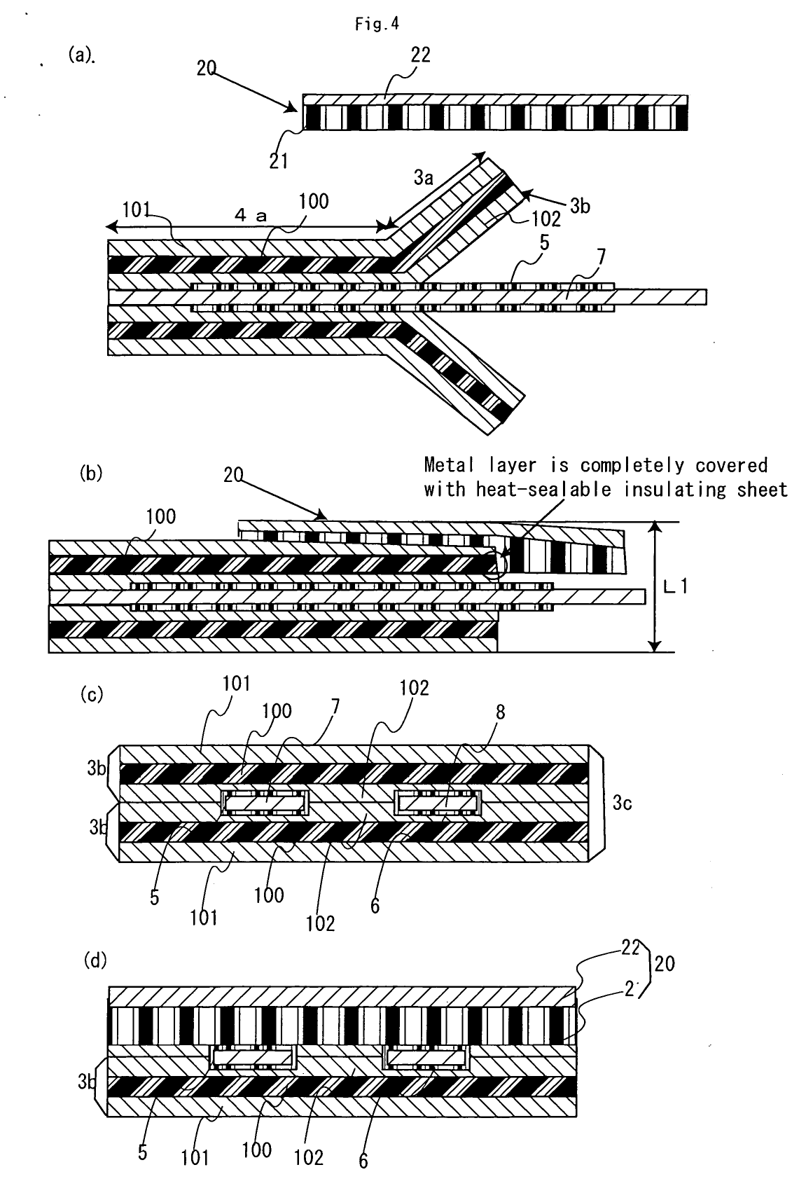

Next, the tab-protruding sealed portion of the cell according to the present invention will be described. Referring to FIG. 4(c), the tab-protruding sealed portion has an outer-casing end surface 3c formed by laminating and sealing two laminate-film cross sections 3b and 3b, and one laminate-film cross section 3b (the laminate film on the upper side in the drawing) of the two laminate-film cross sections 3b and 3b is covered with an insulating sheet 20 that is heat-bonded onto the one cross section 3b, as shown in FIGS. 4(b) and 4(d).

Next, a method of preparing a lithium ion secondary cell of the above structure will be described.

<Preparation of the Positive Electrode>

A positive-electrode active material made of lithium cobalt oxide (LiCoO₂), a carbon conductive agent such as acetylene black and graphite, and a binder made of polyvinylidene fluoride (PVdF) are prepared at a mass ratio of 90:5:5, respectively, and then dissolved and mixed in an organic solvent made of N-methyl-2-pyrrolidone, thus preparing a positive-electrode active-material slurry.

Next, an aluminum foil of 28.5 mm wide (in the crosswise direction of the core body) and 725 mm long (in the longitudinal direction of the core body) is prepared. On both sides of this aluminum-foil core body, the positive-electrode active-material slurry is applied in uniform thickness using a die coater or a doctor blade.

This electrode plate is then passed through a drying apparatus to remove the organic solvent, thus preparing a dried electrode plate with an applied mass of 450 g/m². This dried electrode plate is drawn with pressure to a thickness of 0.16 mm using a roll-pressing apparatus, thus preparing a positive electrode.

While lithium cobalt oxide is used as a positive-electrode active material for the lithium ion secondary cell according to this embodiment, a lithium-containing transition metal composite oxide can be used such as lithium nickel oxide (LiNiO₂), lithium manganese oxide (LiMn₂O₄), lithium iron oxide (LiFeO₂), or an oxide in which part of the transition metal contained in any of the above oxide is substituted with another element. These oxides can be use alone or in mixture of more than one oxide.

<Preparation of the Negative Electrode>

A negative-electrode active material made of artificial graphite having a volume average particle diameter of 20 μm, a binder made of styrene butadiene rubber, and a thickening agent made of carboxy methyl cellulose are prepared at a mass ratio of 98:1:1, respectively, and then mixed with an appropriate amount of water, thus preparing a negative-electrode active-material slurry.

Next, a copper foil of 30.0 mm wide (in the crosswise direction of the core body) and 715 mm long (in the longitudinal direction of the core body) is prepared. On both sides of this copper-foil core body, the negative-electrode active-material slurry is applied in uniform thickness using a die coater or a doctor blade.

This electrode plate is then passed through a drying apparatus to remove the water, thus preparing a dried electrode plate with an applied mass of 200 g/m². This dried electrode plate is drawn with pressure to a thickness of 0.14 mm using a roll-pressing apparatus, thus preparing a negative electrode.

Examples of a negative-electrode active material that can be used for the lithium ion secondary cell according to this embodiment include natural graphite, carbon black, coke, glass carbon, carbon fiber, a carbonaceous substance such as a baked body of any of the foregoing, and a mixture of the carbonaceous substance and at least one selected from the group consisting of lithium, a lithium alloy, and a metal oxide that can intercalate and deintercalate lithium.

<Preparation of the Electrode Assembly>

The positive electrode is brought into connection with a positive-electrode current-collecting tab 7 made of aluminum, and the negative electrode is brought into connection with a negative-electrode current-collecting tab 8 made of nickel. Tab films 5 and 6 made of polypropylene (PP) modified by carboxylic acid are provided at the portions where the respective current-collecting tabs and the tab-protruding sealed portion 4a meet. The positive electrode and the negative electrode are provided therebetween with a micro-porous-film separator made of olefin resin, and then wound using a winding apparatus and taped using a wind-stopping tape, thus completing a flat electrode assembly 1 shown in FIG. 8. It should be noted that the materials for the tab film and separator are not limited to those mentioned above.

<Preparation of the Electrolytic Solution>

Ethylene carbonate (EC), propylene carbonate (PC), and diethyl ethyl carbonate (DEC) are mixed at a volume ratio of 1:1:8 (at an atmospheric pressure of 1 and 25° C.), thus preparing a non-aqueous solvent. As electrolytic salt, LiPF₆ is dissolved in the non-aqueous solvent at 1.0 M (mole/liter), thus preparing an electrolytic solution.

A non-aqueous solvent used for the lithium ion secondary cell according to this embodiment is not limited to the above-mentioned combination; for example, a combination of a highly dielectric solvent and a low viscous solvent can be used. Examples of the highly dielectric solvent include ethylene carbonate, propylene carbonate, butylene carbonate, and γ-butyrolactone, all of which provide high solubility for lithium salt. Examples of the low viscous solvent include diethyl carbonate, dimethyl carbonate, ethyl methyl carbonate, 1,2-dimethoxyethane, tetrahydrofuran, anisole, 1, 4-dioxane, 4-methyl-2-pentanone, cyclohexanone, acetonitrile, propionitrile, dimethylformamide, sulfolane, methyl formate, ethyl formate, methyl acetate, ethyl acetate, propyl acetate, and ethyl propionate. Further, a mixture solvent containing two or more of the highly dielectric solvents and two or more of the low viscous solvents can be used. As electrolytic salt other than LiPF₆, LiN(C₂F₅SO₂)₂, LiN(CF₃SO₂)₂, LiClO₄, and LiBF₄ can be used alone or in mixture of two or more of the foregoing.

<Preparation of the Cell>

The flat electrode assembly 1 and the electrolytic solution are placed in the housing space 2 of the aluminum laminate outer casing 3, which has a three-side sealed structure such that the bottom portion is formed by folding a film and the remaining three sides of the flat shape are sealed. The opening portion of the outer casing is then sealed. Then, as shown in FIG. 4, a heat-sealable insulating sheet 20 having a two-layered structure of polypropylene 21 (30 μm thick)/heat-resistant 22 (polyethylene terephthalate) (12 μm thick) is placed onto one laminate-film cross section 3b (the laminate-film cross section on the upper side in the drawing) of the two laminate-film cross sections 3b and 3b. The insulating sheet is heat-bonded with pressure onto the one cross section 3b at 150° C. Thus, a lithium ion secondary cell according to this embodiment is completed. It should be noted that 150° C. is a temperature lower than the temperature at which the sealed portions 4a, 4b, and 4c are formed.

### EXAMPLE 1

In this example, a cell was prepared in the same manner as in the embodiment.

### Comparative Example 1

A cell was prepared in the same manner as in Example 1 except that instead of placing and heat-bonding the insulating film, an insulating sheet of paper of 0.1 mm thick was placed onto the one cross section 3b.

[Measurement of Thickness]

The thickness of the portions where the current-collecting tabs 7 and 8 were mounted in the cells of Example 1 and Comparative Example 1 was measured (L1 shown in FIG. 4(b)).

The results were such that the thickness was 0.54 mm for Example 1 and 1.15 mm for Comparative Example 1. It can be seen from the results that in Example 1 a reduction in the thickness at the portions of the tabs was accomplished, making it easy to locate in this space a protection circuit or the like.

[Measurement of Frequency of Short Circuits]

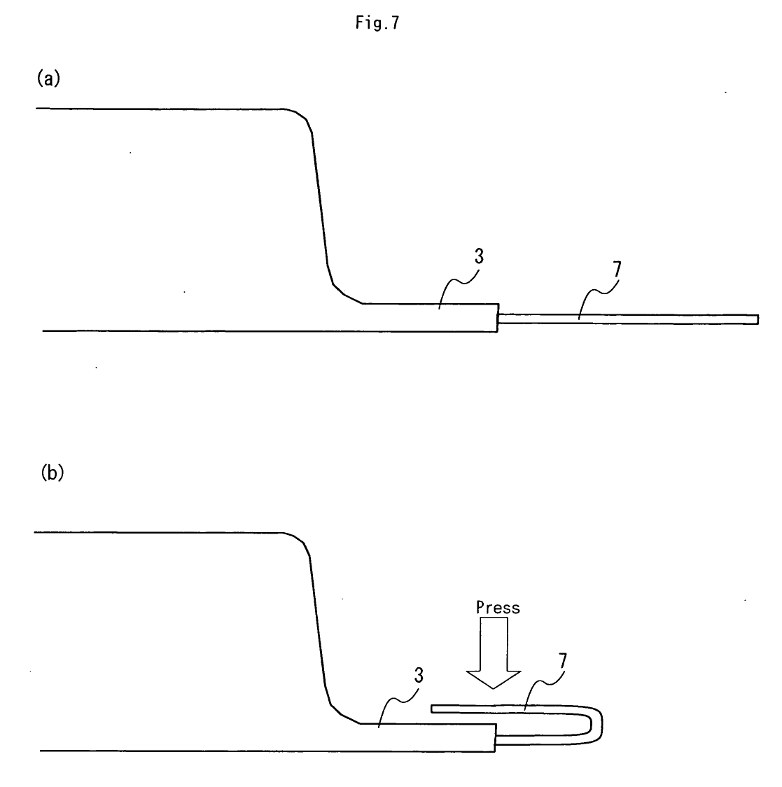

Ten cell samples were prepared each from Example 1 and Comparative Example 1. As shown in FIG. 7(b), the current-collecting tab 7 was folded, and 1 kg of pressure was applied around the base portion of the protruding portion of the current-collecting tab 7, in order to observe, using a tester, the occurrence of a short circuit between the current-collecting tab 7 and the aluminum layer 100 of the laminate film.

In the short circuit test, no short circuits occurred in the ten cell samples from Example 1. Among the ten cell samples from Comparative Example 1, however, three cell samples had short circuits.

It can be seen from the results that the structure of the present invention prevents contact between the current-collecting tab and the metal layer on the outer-casing cross section in a significant degree.

(Supplementary Remarks)

While in the example the description has been made based on a cell of a three-side sealed structure, the present invention will not be limited to this form, but can be applied to any cell with a structure having a tab-protruding portion.

While in the example the insulating sheet is of a two-layered structure, a single-layered structure, a three-layered structure, or a structure with more layers can also be used. It is preferable that there is high adhesivity between the material for the layer of the insulating film to be in contact with the laminate film and the material for the outermost layer of the laminate film. It is more preferable that the both materials are the same.

What is claimed is:

1. A sealed cell comprising:
an electrode assembly comprising a positive electrode having a positive-electrode current-collecting tab, and a negative electrode having a negative-electrode current-collecting tab; and
a film outer casing for housing the electrode assembly, the film outer casing being formed of laminate films each of a metal layer and a resin layer, the laminate films being heat-sealed into a form of a container, wherein:
the film outer casing has a tab-protruding sealed portion formed by heat-sealing while sandwiching the positive and negative electrode current-collecting tabs with tips of thereof protruding outside the film outer casing; and
a heat-sealable insulating sheet is attached to one of cross sections of the laminate films constituting an end surface of the outer casing, whereby the one of the cross sections is covered with the heat-sealable insulating sheet.

2. The sealed cell according to claim 1, wherein the current-collecting tabs each have insulating tab films extending from the tab-protruding sealed portion toward sides of the tips of the current-collecting tabs, the insulating sheet and the tab films being heat-sealed together.

3. The sealed cell according to claim 1, wherein the insulating sheet is of a multi-layered structure including an adhesion layer and a heat-resistant layer, the heat-resistant layer having a melting point and a decomposition temperature higher than those of the adhesion layer.

4. The sealed cell according to claim 2, wherein the insulating sheet is of a multi-layered structure including an adhesion layer and a heat-resistant layer, the heat-resistant layer having a melting point and a decomposition temperature higher than those of the adhesion layer.

5. A method for producing a sealed cell formed of an electrode assembly having a positive electrode having a current-collecting tab and a negative electrode having a current-collecting tab, the electrode assembly being housed in a container-formed outer casing formed of laminate films each of a metal layer and a resin layer with the resin layer being on the inner side, the method comprising:
placing the electrode assembly into the outer casing from an opening portion thereof with tips of the positive and negative current-collecting tabs protruding outside the outer casing, and heat-sealing the opening portion with the positive and negative electrode current-collecting tabs sandwiched between the sealed opening portion, whereby a tab-protruding sealed portion is formed; and
placing an insulating sheet onto one of cross sections of the laminate films constituting an end surface of the outer casing having the current-collecting tabs protruding therethrough, and heat-bonding the insulating sheet with pressure onto the one of the cross sections at a temperature lower than a temperature for heat-sealing the opening portion of the outer casing, whereby the one of the cross sections is covered with the insulating sheet.
